(19) United States
(12) Patent Application Publication
(10) Pub. No.: US 2021/0068387 A1
(43) Pub. Date: Mar. 11, 2021

(54) Wind-Driven Bird Lure

(71) Applicants: Joseph P Regoli, Butte City, CA (US); Kevin D Humphrey, Byron, CA (US)

(72) Inventors: Joseph P Regoli, Butte City, CA (US); Kevin D Humphrey, Byron, CA (US)

(21) Appl. No.: 17/012,484

(22) Filed: Sep. 4, 2020

Related U.S. Application Data
(60) Provisional application No. 62/922,961, filed on Sep. 6, 2019.

(51) Int. Cl. A01M 31/06; F16M 11/08

(52) U.S. Cl. CPC A01M 31/06; F16M 2200/06; F16M 11/08

(57) ABSTRACT

A wind-driven decoy simulates waterfowl wing motion with one or more thin rotatable multi-color blades. Blade motion can be started by pulling on a free end of a control cable connected to an end of one of the blades so as to lift the blade off the ground and expose it to the wind. Conversely, letting the control line go slack drops the blade to the ground and stops further rotation.

### RELATION TO OTHER APPLICATIONS

This application claims the benefit, under 35 U.S.C. 119(e) of prior filed provisional application 62/922,961 filed on 2019 Sep. 6 and naming the same inventors as does the present case.

### BACKGROUND INFORMATION

For centuries hunters have used decoys of one sort or another to attract game. Some small fraction of these decoys have been wind-driven to simulate normal game activity in front of a hunter's blind. Porter, in US 2003/0204983, describes a number of decoys of this sort. Of more specific interest is Rohrke's teaching in U.S. Pat. No. 7,874,093 of a wind-driven lure that simulates water-fowl wing motion with a thin rotating multicolor blade. The disclosure of U.S. Pat. No. 7,874,093 is herein incorporated by reference.

### BRIEF SUMMARY OF THE INVENTION

One aspect of the invention is that it provides apparatus for controlling a wind-driven decoy apparatus which may be selectively switched between an active state in which a pair of elongated blades are free to rotate about respective blade axes to simulate wing motion of waterfowl and an inactive state in which the blades are immobilized by contact with a surface of the earth. Preferred apparatus comprises an earth-penetrating member or portion supporting an upstanding vertical support tube that holds up laterally extending suspension tubes. Each of these suspension tubes has a respective proximal end connected to or partially within the support tube. Each suspension tube has a respective distal end portion having a respective aperture for engaging a respective in-line swivel. Each in-line swivel connects a respective blade to a respective control line portion extending through the respective suspension tube and a portion of the vertical support tube. Each control line passes through a control aperture in a wall of the support tube so that a proximal end of that cable is outside the support tube and available to the operator who can move the apparatus into the active state by pulling the control line or lines taut, causing the associated in-line swivel(s) to engage respective apertures and thus hold the associated blades above the earth so they can be rotated by the wind. Correspondingly, the operator can allow the control line or lines to go slack, in which case the associated blades fall to the surface of the earth under the influence of gravity and are thereby effectively immobilized.

Another aspect of the invention is that it provides a decoy comprising an earth-penetrating portion and a hollow T-shaped portion having two laterally extensive suspension tubes or arms. The T-shaped portion extends upwardly from the earth-penetrating portion to a selected distance above the surface of the earth. There are at least two blade assemblies each of which is shorter than the selected distance. The blade assemblies are preferably connected by a respective in-line swivel to a respective at least one control line extending through the hollow T-shaped portion between a respective swivel receiving aperture adjacent a distal end of the respective laterally extending suspension tube and a control aperture adjacent the earth-penetrating portion. The at least one control line is movable between a taut setting in which a respective proximal end of each swivel is in abutting contact with the associated swivel aperture and a slack setting in which both blades are in contact with the earth.

Those skilled in the art will recognize that the foregoing broad summary description is not intended to list all of the features and advantages of the invention. Both the underlying ideas and the specific embodiments disclosed in the following Detailed Description may serve as a basis for alternate arrangements for carrying out the purposes of the present invention and such equivalent constructions are within the spirit and scope of the invention in its broadest form. Moreover, different embodiments of the invention may provide various combinations of the recited features and advantages of the invention, and that less than all of the recited features and advantages may be provided by some embodiments.

### BRIEF DESCRIPTION OF THE SEVERAL VIEWS OF THE DRAWING

FIG. 1 is a partly schematic perspective view of an embodiment of the invention in which one of two wind-movable blades is selectively inactivated.

FIG. 2 is a partial cutaway view of a second embodiment, the view showing assembly detail of an upper end of the support tube.

FIG. 3 is a largely schematic view of a bifurcated control line portion used in some embodiments of the invention.

### DETAILED DESCRIPTION OF A PREFERRED EMBODIMENT

In studying this Detailed Description, the reader may be aided by noting definitions of certain words and phrases used throughout this patent document. Wherever those definitions are provided, those of ordinary skill in the art should understand that in many, if not most, instances such definitions apply both to preceding and following uses of such defined words and phrases.

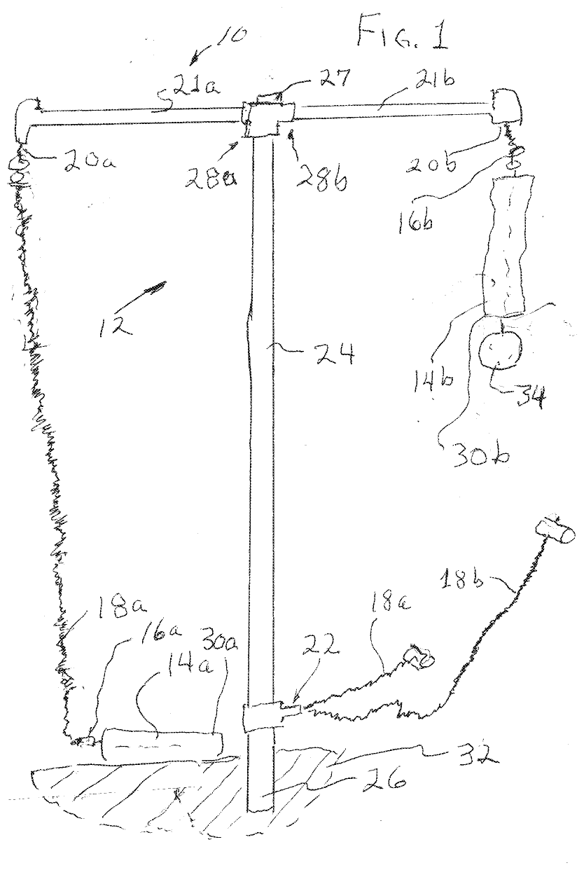

Turning now to FIG. 1 one finds a depiction of an exemplar decoy apparatus of the invention 10, the preferred apparatus comprising a generally T-shaped hollow body 12 and at least one rotatable reflective member 14a, 14b connected by a swivel 16a, 16b to a control line 18a, 18b that passes through the T-shaped body from a distal aperture 20a, 20b adjacent an end of a lateral arm 21a, 21b of that body to a proximal control aperture 22 in the vertically extensive portion 24 of the body 12.

An exemplar hollow body 12 may comprise an earth-penetrating member 26 supporting an upstanding vertical support tube 24, at least one laterally extending suspension tube 21a, 21b having a proximal end 28a, 28b adjacent the support tube 24 and a distal end 20a, 20b having a swivel-engaging aperture respectfully associated therewith. In many cases the decoy 10 is used in a marshy setting where the ground is soft and a pointy end of a pipe or tube provides for easy set-up. The reader will recognize that other mounting arrangements can be used and may comprise driving a metal rod into rocky ground and then strapping a lower portion of the support tube to the driven rod.

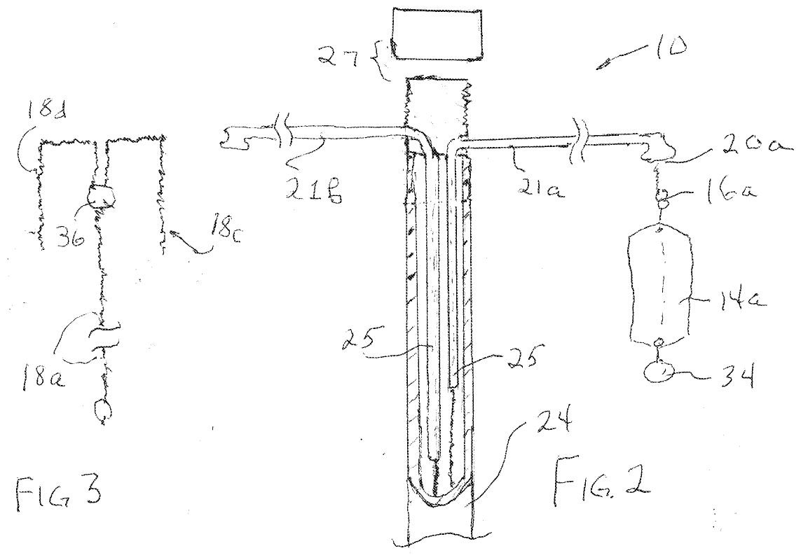

Other arrangements of the support tube and suspension tubes may be considered. For example, as depicted in FIG. 2, the laterally extending support 21a, 21b may be a portion of a bent tubular member comprising a downwardly extending portion 25 within the overall support tube 24.

Various embodiments of the decoy apparatus may use different arrangements of access ports 27 to aid in threading the control line or lines through the hollow body 12. Moreover, the hollow body 12 may comprise a variety of conventional plumbing pipes and fittings.

In an active state of the decoy 10 the control line 18a,b is pulled taut so that one end of the swivel 16a, 16b is held stationary against a wall of the hollow body 12 while the other end of the swivel is free to rotate with the reflective member 14a, 14b without twisting or tangling the control line 18a,18b. The decoy 10 may be inactivated by letting the control line go slack, and allowing the reflective member to fall to the earth, which stops its rotation.

In some embodiments the rotatable reflective members 14a,14b are elongated blades having a sigmoidal cross section. It should be recognized that alternate arrangements, such as having multiple short blades instead of one longer one, can be considered. In a preferred arrangement the lengths of the single blades are selected so that the lower end 30a,30b of the associated blade 14a,14b does not contact the ground 32 when the blade is supposed to be active.

In some embodiments each rotating reflector has a deadweight 34 attached to the end of the blade distal from the control line. This weight keeps the distal end of the blade from flapping about for a range of expected wind speeds and provides a more positive release and drop when a control line goes slack.

In a particular preferred embodiment the decoy apparatus 10 comprises two rotatable reflective members 14a, 14b, each of which has its own control line 18a, 18b. In this case the decoy is fully inactive when both control lines are slack and is fully active when both lines are taut. This arrangement allows the hunter more flexibility in decoy operation.

Alternately, one can configure a decoy having a partly bifurcated control line as depicted in FIG. 3. Here a knot or clamping arrangement 36 separates a single control line portionl 8c from a dual line portion 18d. This allows the user to operate two blades using a single line. A shortcoming of this arrangement is that the lengths of the two ropes in the bifurcated section must be carefully controlled so that in the active state both blade swivels effectively engage respective apertures. Moreover, the bifurcated section must be long enough to allow the blades to lie fully flat on the ground when inactive.

Although the present invention has been described with respect to several preferred embodiments, many modifications and alterations can be made without departing from the invention. Accordingly, it is intended that all such modifications and alterations be considered as being within the spirit and scope of the invention as defined in the attached claims.

1) A wind-driven decoy having an active state in which an elongated blade is rotatable by the wind about a blade axis and an inactive state in which the blade is immobilized by contact with a surface of the earth, the apparatus comprising:
an earth-penetrating member supporting an upstanding vertical support tube;
at least one laterally extending suspension tube having a proximal end adjacent the support tube and a distal end having an aperture therein;
an in-line swivel connecting the blade to a distal end portion of a control line extending through the aperture, the suspension tube and a portion of the vertical support tube, the control line passing through a control aperture in a wall of the support tube to a proximal end external to the support tube whereby the apparatus is in the inactive state when the control line is slack and is in the active state when the control line is taut and the blade is lifted off the surface of the earth.

2) decoy of claim 1 further comprising:
a second elongate blade having a respective blade axis;
a second laterally extending suspension tube having a respective proximal end adjacent the support tube and a respective distal end having a respective second aperture thereadjacent;
a second in-line swivel respectively connecting the second blade to a respective distal end portion of a second control line extending through the second aperture, the second suspension tube and a portion of the vertical support tube, the second control line passing through the control aperture in the wall of the support tube to a proximal end external to the support tube whereby the apparatus is in the inactive state when both control lines are slack and is in the active state when either control line is taut and the associated blade is lifted off the surface of the earth.

3) decoy of claim 1 further comprising:
a second elongate blade having a respective blade axis;
a second laterally extending suspension tube having a respective proximal end adjacent the support tube and a respective distal end having a respective aperture thereadjacent;
a second in-line swivel connecting the second blade to a second distal end portion of the control line thereby forming a bifurcated control line whereby the apparatus is in the inactive state when the control line is slack and is in the active state when the control line is taut and both blades are lifted off the surface of the earth.

4) A decoy comprising an earth-penetrating portion and a hollow T-shaped portion extending upwardly therefrom to a selected distance above the surface of the earth;
two control lines extending through the hollow portion from a lower opening adjacent the earth-penetrating portion to respective upper openings adjacent respective ends of respective laterally extending portions of the T-shaped portion; and
two elongated blades each having a length less than the selected distance, each blade respectively connected by a respective in-line swivel to a respective control line whereby each blade is free to rotate when the respective control line lifts that blade off the surface of the earth but is prohibited from rotation when the associated control line is slack and the blade lies in contact with the surface of the earth.

5) A decoy comprising an earth-penetrating portion and a hollow T-shaped portion comprising two laterally extensive suspension tubes, the T-shaped portion extending upwardly from the earth-penetrating portion to a selected distance above the surface of the earth;
at least two blade assemblies each shorter than the selected distance and each connected by a respective in-line swivel to a respective control line extending through the hollow T-shaped portion between a respective swivel receiving aperture adjacent a distal end of the respective laterally extending suspension tube and a control aperture adjacent the earth-penetrating portion, the respective control line movable between a respective taut setting in which the proximal end of the respective swivel is in abutting contact with the associated swivel aperture and a respective slack setting in which the associated blade assembly contacts the surface of the earth.
